(19) United States
(12) Patent Application Publication
(10) Pub. No.: US 2005/0259734 A1
(43) Pub. Date: Nov. 24, 2005

(54) Motion vector generator for macroblock adaptive field/frame coded video data

(76) Inventor: Timothy Hellman, Concord, MA (US)

Correspondence Address: MCANDREWS HELD & MALLOY, LTD, 500 WEST MADISON STREET, SUITE 3400, CHICAGO, IL, 60661, US

(21) Appl. No.: 10/888,680

(22) Filed: Jul. 9, 2004

Related U.S. Application Data
(60) Provisional application No. 60/573,321, filed on May 21, 2004.

(51) Int. Cl. H04N 7/12

(52) U.S. Cl. 375/240.16; 375/240.24

(57) ABSTRACT

Described herein are motion vector generator(s) for decoding macroblock adaptive field/frame coded video data. The motion vector generator comprises arithmetic logic and a neighbor buffer. The arithmetic logic calculates motion vectors for a portion of a picture. The neighbor buffer stores information about another portion of the picture, the another portion being adjacent to the portion. The arithmetic logic calculates the motion vectors based on the information about the another portion of the picture.

### RELATED APPLICATIONS

This application claim priority to “MOTION VECTOR GENERATOR FOR MACROBLOCK ADAPTIVE FIELD/FRAME CODED VIDEO DATA”, Provisional application for U.S. Pat., Ser. No. 60/573,321, filed May 21, 2004, by Hellman.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Encoding standards often use recursion to compress data. In recursion, data is encoded as a mathematical function of other previous data. As a result, when decoding the data, the previous data is needed.

An encoded picture is often assembled in portions. Each portion is associated with a particular region of the picture. The portions are often decoded in a particular order. For decoding some of the portions, data from previously decoded portions is needed.

A video decoder typically includes integrated circuits for performing computationally intense operations, and memory. The memory includes both on-chip memory and off-chip memory. On-chip memory is memory that is located on the integrated circuit and can be quickly accessed. Off-chip memory is usually significantly slower to access then on-chip memory.

During decoding, storing information from portions that will be used for decoding later portions in on-chip memory is significantly faster than storing the information off-chip. However, on-chip memory is expensive, and consumes physical area of the integrated circuit. Therefore, the amount of data that on-chip memory can store is limited. In contrast, decoded video data generates very large amounts of data. Therefore, it may be impractical to store all of the decoded data on-chip.

The data needed for decoding a portion is typically contained in the neighboring portions that are decoded prior to the portion, such as the left neighbor. For example, in the H.264 standard, motion vectors associated with a macroblock can be predicted from motion vectors associated with the left, top left, top, and top right neighboring macroblocks.

The information from the left, top left, top, and right neighboring portions may not be determinable until the decoding of the portion. For example, in H.264, macroblock pairs of interlaced frames may be encoded using macroblock adaptive field/frame coding. Where macroblock adaptive field/frame coding is used, the information needed from each neighboring portion depends on whether the portion and the neighboring portion are field or frame coded.

Limitations and disadvantages of conventional and traditional approaches will become apparent to one of ordinary skill in the art through comparison of such systems with the present invention as set forth in the remainder of the present application with reference to the drawings.

### BRIEF SUMMARY OF THE INVENTION

Described herein are motion vector generator(s) for decoding macroblock adaptive field/frame coded video data.

In one embodiment, there is presented a motion vector generator for generating motion vectors. The motion vector comprises arithmetic logic and a neighbor buffer. The arithmetic logic calculates motion vectors for a portion of a picture. The neighbor buffer stores information about another portion of the picture, the another portion being adjacent to the portion. The arithmetic logic calculates the motion vectors based on the information about the another portion of the picture.

In another embodiment, there is presented an integrated circuit for generating motion vectors. The integrated circuit comprises arithmetic logic and a neighbor buffer. The arithmetic logic is operable to calculate motion vectors for a portion of a picture. The neighbor buffer is operable to store information about another portion of the picture, said another portion being adjacent to the portion, the neighbor connected to the arithmetic logic. The arithmetic logic calculates the motion vectors based on the information about the another portion of the picture.

These and other advantages and novel features of the present invention, as well as illustrated embodiments thereof will be more fully understood from the following description and drawings.

### BRIEF DESCRIPTION OF SEVERAL VIEWS OF THE DRAWINGS

FIG. 1 is a block diagram of an exemplary frame;

FIG. 2A is a block diagram describing spatially predicted macroblocks;

FIG. 2B is a block diagram describing temporally predicted macroblocks;

FIG. 2C is a block diagram describing predicted motion vectors;

FIG. 2D is a block diagram describing the encoding of a prediction error;

FIG. 3 is a block diagram describing the encoding of macroblocks for interlaced fields in accordance with macroblock adaptive frame/field coding;

FIG. 4 is a block diagram of a video decoder in accordance with an embodiment of the present invention;

FIG. 5 is a block diagram of a symbol interpreter in accordance with an embodiment of the present invention;

FIG. 6 is a block diagram describing the determination for motion vectors for a partition exceeding 4×4 pixels;

FIG. 7 is a block diagram describing the decoding order for a video decoder in accordance with an embodiment of the present invention;

FIG. 8 is a block diagram describing top neighboring partitions;

FIG. 9 is a block diagram describing left neighboring partitions;

FIG. 10 is a block diagram describing the top left corner and top right corner neighboring partitions; and

FIG. 11 is a block diagram describing a motion vector generator in accordance with an embodiment of the present invention.

### DETAILED DESCRIPTION OF THE INVENTION

According to certain aspects of the present invention, motion vectors from other partitions that are needed to decoded a partition are stored in an on-chip memory. The foregoing improves the throughput rate by reducing the number of DRAM accesses, as well as allowing DRAM accesses to occur concurrently with other processing functions.

An exemplary video encoding standard, the ITU-H.264 Standard (H.264) (also known as MPEG-4, Part 10, and Advanced Video Coding), will now be described to illustrate exemplary interdependencies between motion vectors associated with portions of an image.

H.264 Standard

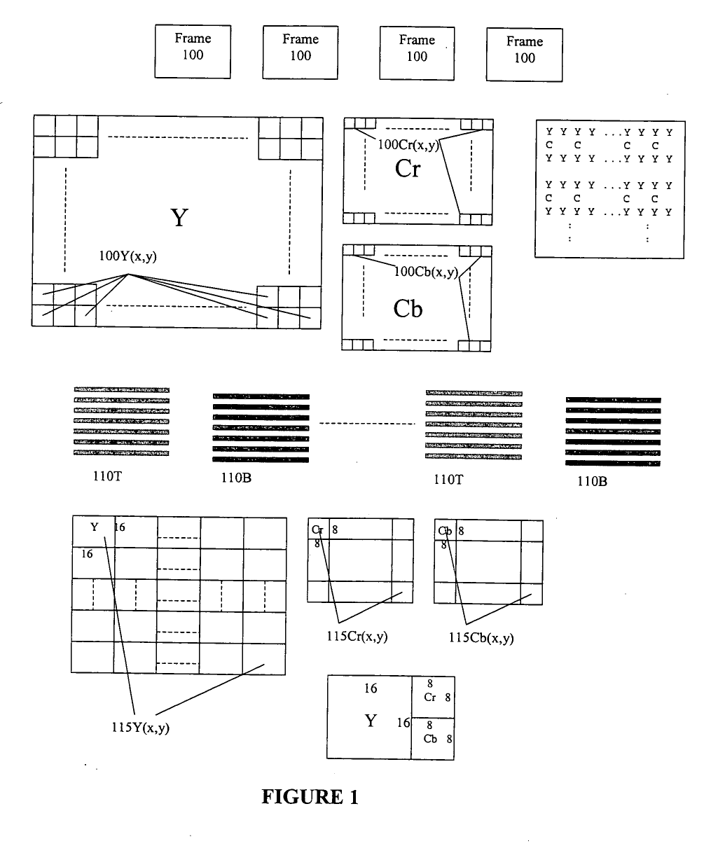

Referring now to FIG. 1, there is illustrated a block diagram of a frame 100. A video camera captures frames 100 from a field of view during time periods known as frame durations. The successive frames 100 form a video sequence. A frame 100 comprises two-dimensional grid(s) of pixels 100 (x,y).

For color video, each color component is associated with a two-dimensional grid of pixels. For example, a video can include luma, chroma red, and chroma blue components. Accordingly, the luma, chroma red, and chroma blue components are associated with a two-dimensional grid of pixels 100Y(x,y), 100Cr(x,y), and 100Cb(x,y), respectively. When the grids of two dimensional pixels 100Y(x,y), 100Cr(x,y), and 100Cb(x,y) from the frame are overlayed on a display device 110, the result is a picture of the field of view at the frame duration that the frame was captured.

Generally, the human eye is more perceptive to the luma characteristics of video, compared to the chroma red and chroma blue characteristics. Accordingly, there are more pixels in the grid of luma pixels 100Y(x,y) compared to the grids of chroma red 100Cr(x,y) and chroma blue 100Cb(x,y). In the MPEG 4:2:0 standard, the grids of chroma red 100Cr(x,y) and chroma blue pixels 100Cb(x,y) have half as many pixels as the grid of luma pixels 100Y(x,y) in each direction.

The chroma red 100Cr(x,y) and chroma blue 100Cb(x,y) pixels are overlayed the luma pixels in each even-numbered column 100Y(x, 2y) between each even, one-half a pixel below each even-numbered line 100Y(2x, y). In other words, the chroma red and chroma blue pixels 100Cr(x,y) and lOOCb(x,y) are overlayed pixels l00Y(2x+ 1/2y).

If the video camera is interlaced, the video camera captures the even-numbered lines 100Y(2x,y), 100Cr(2x,y), and 100Cb(2x,y) during half of the frame duration (a field duration), and the odd-numbered lines 100Y(2x+1,y), 100Cr(2x+1,y) , and 100Cb(2x+1,y) during the other half of the frame duration. The even numbered lines 100Y(2x,y), 100Cr(2x,y), and 100Cb(2x,y) what is known as a top field 110T, while odd-numbered lines 100Y(2x+1,y), 100Cr(2x+1,y), and 100Cb(2x+1,y) form what is known as the bottom field 110B. The top field 110T and bottom field 110T are also two dimensional grid(s) of luma 110YT(x,y), chroma red 110CrT(x,y), and chroma blue 110CbT(x,y) pixels.

A luma pixel of the frame 100Y(x,y), or top/bottom fields 110YT/B(x,y) can be divided into 16×16 pixel 100Y(16x->16x+15, 16y->16y+15) blocks 115Y(x,y). For each block of luma pixels 115Y(x,y), there is a corresponding 8x8 block of chroma red pixels 115Cr(x,y) and chroma blue pixels 115Cb(x,y) comprising the chroma red and chroma blue pixels that are to be overlayed the block of luma pixels 115Y(x,y). A block of luma pixels 115Y(x,y), and the corresponding blocks of chroma red pixels 115Cr(x,y) and chroma blue pixels 115Cb(x,y) are collectively known as a macroblock 120. The macroblocks 120 can be grouped into groups known as slice groups 122.

The H.264 standard encodes video on a frame by frame basis, and encodes frames on a macroblock by macroblock basis. H.264 specifies the use of spatial prediction, temporal prediction, transformation, interlaced coding, and lossless entropy coding to compress the macroblocks 120.

Unless otherwise specified, it is assumed the pixel dimensions for a unit, such as a macroblock or partition, shall generally refer to the dimensions of the luma pixels of the unit. Also, and unless otherwise specified, it is assumed that a unit with a given pixel dimension shall also generally include the corresponding chroma red and chroma blue pixels that overlay the luma pixels. However, these assumptions shall not operate to limit the scope of the present invention. The dimensions of the chroma red and chroma blue pixels for the unit depend on whether MPEG 4:2:0, MPEG 4:2:2 or other format is used, and may differ from the dimensions of the luma pixels.

Spatial Prediction

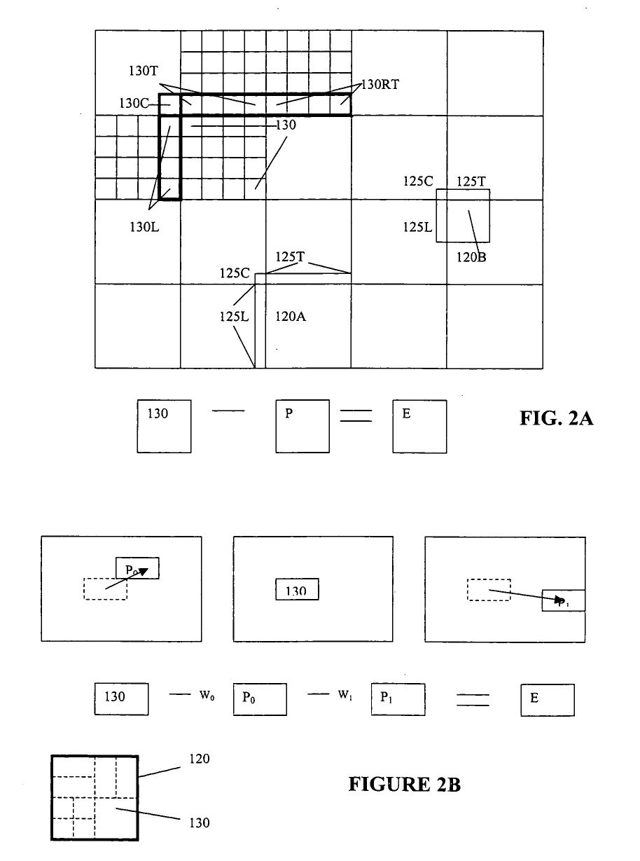

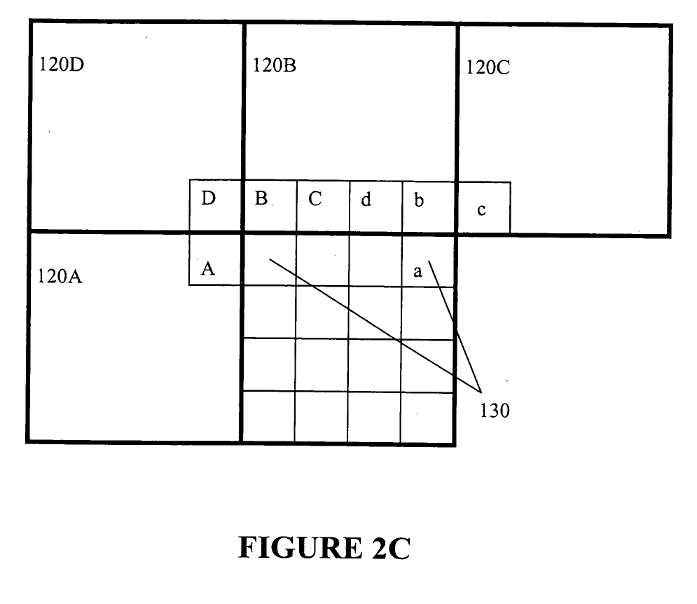

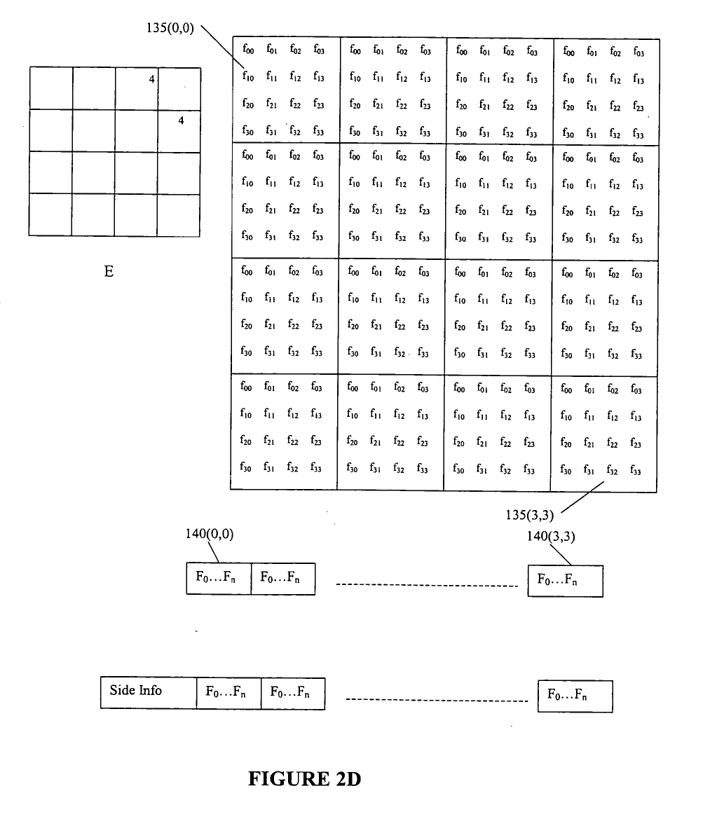

Referring now to FIG. 2A, there is illustrated a block diagram describing spatially encoded macroblocks 120. Spatial prediction, also referred to as intraprediction, involves prediction of frame pixels from neighboring pixels. The pixels of a macroblock 120 can be predicted, either in a 16×16 mode, an 8×8 mode, or a 4×4 mode.

In the 16×16 and 8×8 modes, e.g, macroblock 120a, and 120b, respectively, the pixels of the macroblock are predicted from a combination of left edge pixels 125L, a corner pixel 125C, and top edge pixels 125T. The difference between the macroblock 120a and prediction pixels P is known as the prediction error E. The prediction. error E is calculated and encoded along with an identification of the prediction pixels P and prediction mode, as will be described.

In the 4×4 mode, the macroblock 120c is divided into 4×4 partitions 130. The 4×4 partitions 130 of the macroblock 120a are predicted from a combination of left edge partitions 130L, a corner partition 130C, right edge partitions 130R, and top right partitions 130TR. The difference between the macroblock 120a and prediction pixels P is known as the prediction error E. The prediction error E is calculated and encoded along with an identification of the prediction pixels and prediction mode, as will be described. A macroblock 120 is encoded as the combination of the prediction errors E representing its partitions 130.

Temporal Prediction

Referring now to FIG. 2B, there is illustrated a block diagram describing temporally encoded macroblocks 120. The temporally encoded macroblocks 120 can be divided into 16×8, 8×16, 8×8, 4×8, 8×4, and 4×4 partitions 130. Each partition 130 of a macroblock 120, is compared to the pixels of other frames or fields for a similar block of pixels P. A macroblock 120 is encoded as the combination of the prediction errors E representing its partitions 130.

The similar block of pixels is known as the prediction pixels P. The difference between the partition 130 and the prediction pixels P is known as the prediction error E. The prediction error E is calculated and encoded, along with an identification of the prediction pixels P. The prediction pixels P are identified by motion vectors MV. Motion vectors MV describe the spatial displacement between the partition 130 and the prediction pixels P. The motion vectors MV can, themselves, be predicted from neighboring partitions.

The partition can also be predicted from blocks of pixels P in more than one field/frame. In bi-directional coding, the partition 130 can be predicted from two weighted blocks of pixels, P0 and P1. According a prediction error E is calculated as the difference between the weighted average of the prediction blocks w0P0+w1p1 and the partition 130. The prediction error E, an identification of the prediction blocks P0, P1 are encoded. The prediction blocks P0 and P1 are identified by motion vectors MV.

The weights w0, w1 can also be encoded explicitly, or implied from an identification of the field/frame containing the prediction blocks P0 and P1. The weights w0, w1 can be implied from the distance between the frames/fields containing the prediction blocks P0 and P1 and the frame/field containing the partition 130. Where TO is the number of frame/field durations between the frame/field containing P0 and the frame/field containing the partition, and T1 is the number of frame/field durations for P1,
w0=1−T0/(T0+T1)
w1=1−T1/(T0 +T1)

For a high definition television picture, there are thousands of macroblocks 120 per frame 100. The macroblocks 120, themselves can be partitioned into potentially 16 4×4 partitions 130, each associated with potentially different motion vector sets. Thus, coding each of the motion vectors without data compression can require a large amount of data and bandwidth.

Motion Vector Interdependencies

To reduce the amount of data used for coding the motion vectors, the motion vectors themselves are predicted. Referring now to FIG. 2C, there is illustrated a block diagram describing motion vector interdependencies for exemplary partitions 130. The motion vectors for the partition 130 can be predicted from the left A, top left corner D, top B, and top right corner C neighboring partitions. For example, the median of the motion vector(s) for A, B, C, and D can be calculated as the prediction value. The motion vector(s) for partition 130 can be coded as the difference (mvDelta) between itself and the prediction value. Thus the motion vector(s) for partition 130 can be represented by an indication of the prediction, median (A,B,C,D) and the difference, mvDelta. Where mvDelta is small, considerable memory and bandwidth are saved.

However, where partition 130 is at the top left corner of a macroblock 120, e.g., partition 130(1), partition A is in the left neighboring macroblock 120A, partition D is in the top left neighboring macroblock 120D, while partitions B and C are in macroblock 120B. Where partition 130 is at the top right corner of a macroblock 120, e.g., partition 130(2), the top left corner d and the top b neighboring partitions are in the top neighboring macroblock 120B, while the top right corner neighboring partition c is in the top right corner neighboring macroblock 120C.

Although the interdependencies are shown for 4×4 partitions, similar dependencies can exist for other sized partitions.

Transformation, Quantization, And Scanning

Referring now to FIG. 2D, there is illustrated a block diagram describing the encoding of the prediction error E. With both spatial prediction and temporal prediction, the macroblock 120 is represented by a prediction error E. The prediction error E is also two- dimensional grid of pixel values for the luma Y, chroma red Cr, and chroma blue Cb components with the same dimensions as the macroblock 120.

A transformation transforms 4×4 partitions 130(0,0) . . . 130(3,3) of the prediction error E to the frequency domain, thereby resulting in corresponding sets 135(0,0) . . . 135(3,3) of frequency coefficients f₀₀ . . . f₃₃. The sets of frequency coefficients are then quantized and scanned, resulting in sets 140(0,0) . . . 140(3,3) of quantized frequency coefficients, F₀ . . . Fₙ. A macroblock 120 is encoded as the combination of its partitions 130.

Macroblock Adaptive Frame/Field (Mbaff) Coding

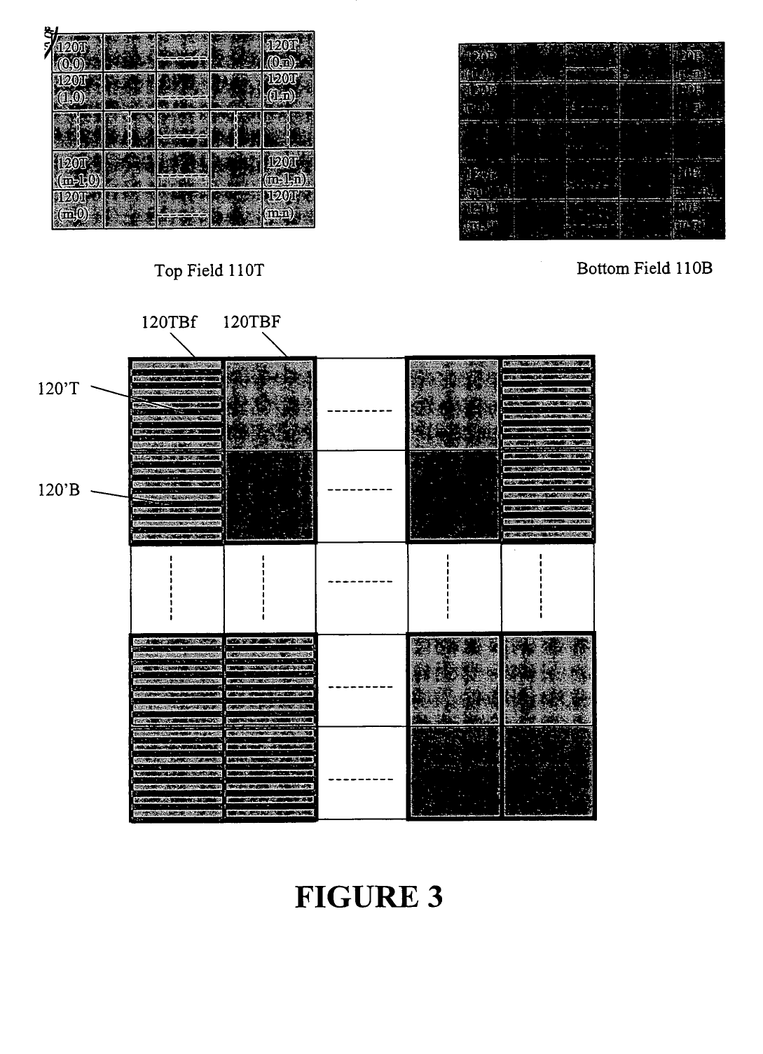

Referring now to FIG. 3, there is illustrated a block diagram describing the encoding of macroblocks 120 for interlaced fields. As noted above, interlaced fields, top field 110T(x,y) and bottom field 110B(x,y) represent either even or odd-numbered lines.

In MBAFF, each macroblock 120T in the top frame is paired with the macroblock 120B in the bottom frame, that is interlaced with it. The macroblocks 120T and 120B are then coded as a macroblock pair 120TB. The macroblock pair 120TB can either be field coded, i.e., macroblock pair 120TBF or frame coded, i.e., macroblock pair 120TBf. Where the macroblock pair 120TBF are field coded, the macroblock 120T is encoded, followed by macroblock 120B. Where the macroblock pair 120TBf are frame coded, the macroblocks 120T and 120B are deinterlaced. The foregoing results in two new macroblocks 120′T, 120′B. The macroblock 120′T is encoded, followed by macroblock 120′B.

Entropy Coding

Referring again to FIG. 2D, the macroblocks 120 are represented by a prediction error E that is encoded as sets 140(0,0) . . . 140(3,3) of quantized frequency coefficients F₀ . . . Fₙ. The macroblock 120 are also represented by side information, such as prediction mode indicators, and identification of prediction blocks. The foregoing can be either Context Adaptive Variable Length Coded (CAVLC) or Context Adaptive Binary Arithmetic Coded (CABAC).

The frames 100 are encoded as the macroblocks 120 forming them. The video sequence is encoded as the frame forming it. The encoded video sequence is known as a video elementary stream. The video elementary stream is a bitstream that can be transmitted over a communication network to a decoder. Transmission of the bitstream instead of the video sequence consumes substantially less bandwidth.

As can be seen from the foregoing discussion, the data needed for calculating motion vectors for a macroblock pair includes motion vectors associated with the left, top left, top, and top right neighboring macroblock pairs. During decoding, storing information from portions that will be used for decoding later portions in on-chip memory is significantly faster than storing the information off- chip. However, on-chip memory is expensive, and consumes physical area of the integrated circuit. Therefore, the amount of data that on-chip memory can store is limited. In contrast, decoded video data generates very large amounts of data.

Additionally, where macroblock adaptive field/frame coding is used, the information needed from each of the neighboring macroblock pairs depends on whether the macroblock pair and the neighboring macroblock pairs are field or frame coded.

A video decoder, wherein motion vectors from macroblock pairs that are need to decode a macroblock pair are stored in an on-chip memory, will now be presented. The macroblock pairs can be macroblock adaptive field/frame coded. The foregoing improves the throughput rate by reducing the number of DRAM accesses, as well as allows DRAM accesses to occur concurrently with other processing functions.

Video Decoder

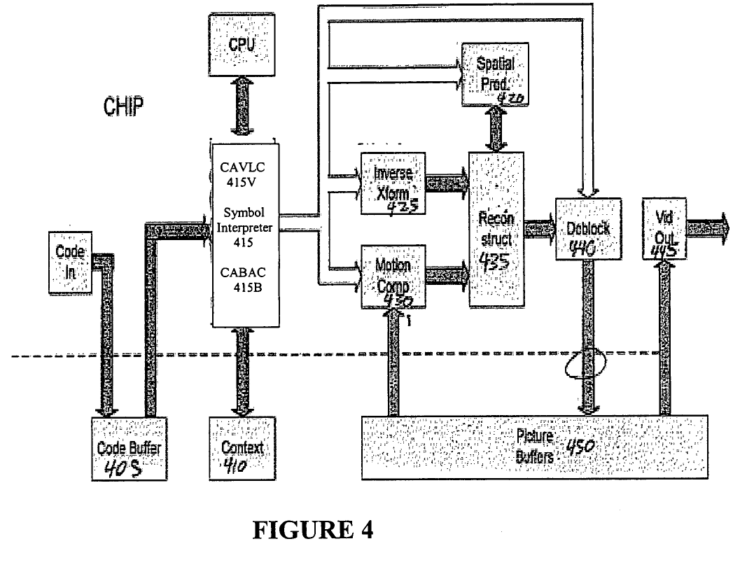

Referring now to FIG. 4, there is illustrated a block diagram describing an exemplary video decoder 400 in accordance with an embodiment of the present invention. The video decoder 400 includes a code buffer 405 for receiving a video elementary stream. The code buffer 405 can be a portion of a memory system, such as a dynamic random access memory (DRAM). A symbol interpreter 415 in conjunction with a context memory 410 decode the CABAC and CAVLC symbols from the bitstream. The context memory 410 can be another portion of the same memory system as the code buffer 405, or a portion of another memory system.

The symbol interpreter 415 includes a CAVLC decoder 415V and a CABAC decoder 415B. The motion vector data can either be CAVLC or CABAC coded. Accordingly, either the CAVLC decoder 415V or CABAC decoder 415B decodes the CAVLC or CABAC coding of the motion vectors data.

The symbol interpreter 415 provides the sets of scanned quantized frequency coefficients F₀ . . . Fₙ, to an inverse scanner, quantizer, and transformer (ISQDCT) 425. Depending on the prediction mode for the macroblock 120 associated with the scanned quantized frequency coefficients F₀ . . . Fₙ, the symbol interpreter 415 provides and motion vectors to the motion compensator 430, where motion compensation is used. Where spatial prediction is used, the symbol interpreter 415 provides side information to the spatial predictor 420.

The ISQDCT 425 constructs the prediction error E. The spatial predictor 420 generate the prediction pixels P for spatially predicted macroblocks while the motion compensator 430 generates the prediction pixels P, or P0, P1 for temporally predicted macroblocks. The motion compensator 430 retrieves the prediction pixels P, or P0, P1 from picture buffers 450 that store previously decoded frames 100 or fields 110.

A pixel reconstructor 435 receives the prediction error E from the ISQDCT 425, and the prediction pixels from either the motion compensator 430 or spatial predictor 420. The pixel reconstructor 435 reconstructs the macroblock 120 from the foregoing information and provides the macroblock 120 to a deblocker 440. The deblocker 440 smoothes pixels at the edge of the macroblock 120 to prevent the appearance of blocking. The deblocker 440 writes the decoded macroblock 120 to the picture buffer 450.

A display engine 445 provides the frames 100 from the picture buffer 450 to a display device. The symbol interpreter 415, the ISQDCT 425, spatial predictor 420, motion compensatory 430, pixel reconstructor 435, and display engine 445 can be hardware accelerators under the control of a central processing unit (CPU).

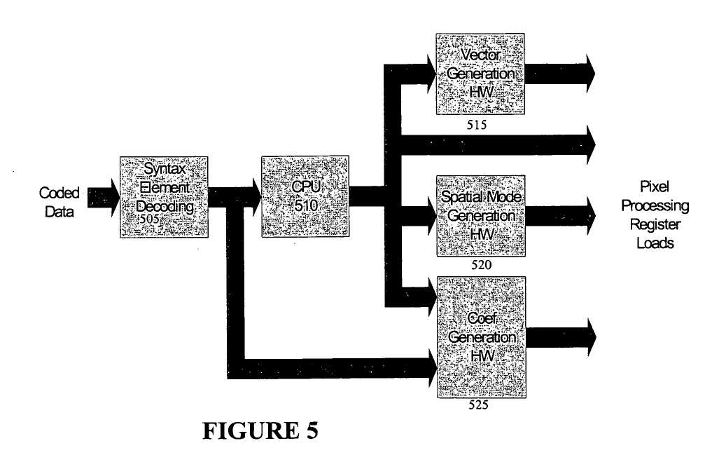

Referring now to FIG. 5, there is illustrated a block diagram describing the symbol interpreter 415 in accordance with an embodiment of the present invention. The symbol interpreter comprises a syntax element decoder 505, a processor 510, a motion vector generator 515, spatial mode generation hardware 520, and coefficient generation hardware 525. The processor 510 can comprise, a general purpose processor.

The syntax element decoder 510 decodes the syntax of the video data. From the decoded syntax, information regarding the motion vectors, including the prediction mode and difference mvDelta are provided to the vector generation hardware. The vector generation hardware 515 decodes the motion vectors for each partition 130.

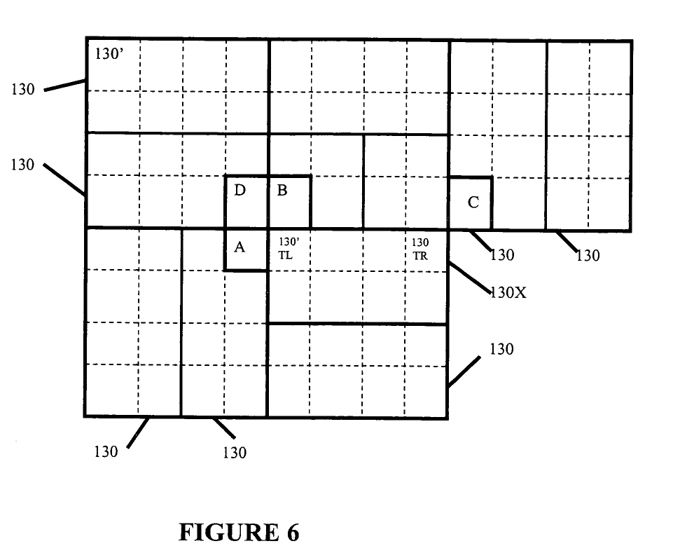

Referring now to FIG. 6, there is illustrated a block diagram describing the determination of motion vectors for partitions 130 that exceeds 4x4 pixels. Where the partition, e.g., partition 130X, exceeds 4x4 pixels, it is treated as its constituent set of 4x4 pixel partitions 130′. Each of the 4x4 constituent partitions 130′ is associated with the motion vector set for the partition 130.

As noted above, the motion vectors for the partitions 130 are predicted from the motion vectors from the left, top left corner, top, and top right corner neighboring partitions. Where the partition 130 is larger than 4x4, e.g., partition 130X, the motion vector generator 515 selects the top left corner 4×4 constituent partition 130′ TL and the top right corner 4×4 constituent partition 130′ TR. The motion vector generator 515 uses the left A, top left corner D, and top B neighboring 4×4 constituent partitions 130′ for the top left corner 4×4 constituent partition and the top right corner C neighboring 4×4 constituent for the top right corner 4×4 constituent partition, to determine the motion vectors for the partition 130.

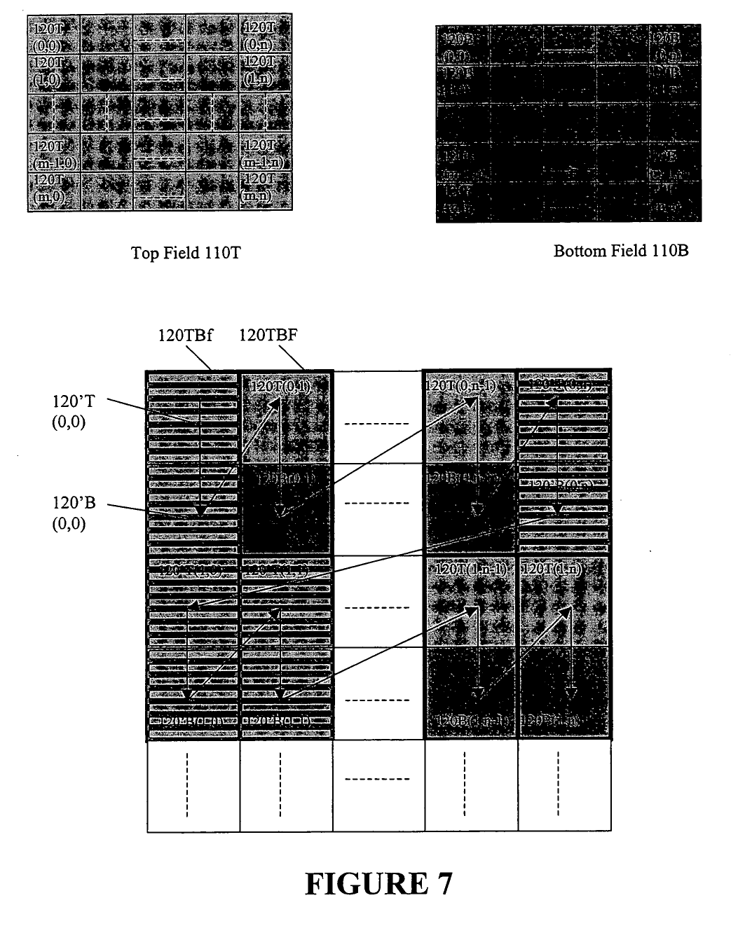

Referring now to FIG. 7, there is illustrated a block diagram describing the decoding order of the video decoder, in accordance with an embodiment of the present invention. For interlaced fields 110T, 110B with MBAFF encoding, the video decoder 400 decodes the macroblocks in pairs, starting with the macroblock pair 120T(0,0), 120B(0,0) at the top corners of the top field 110T and bottom field 110B and proceeding across the top row of macroblocks 120T(0,n), 120B(0,n). The video decoder 400 then proceeds to the left most macroblock of the next row of macroblocks 120T(1,0), 120B(1,0) and proceeds to the right, and so forth.

The macroblock pairs represent 32×16 pixel blocks of the frame 100. However, where the macroblock pairs are frame coded, such as macroblocks 120TBf, the reconstructed macroblocks 120′T(0,0), 120′B(0,0) represented the top and bottom halves of macroblocks 120T(0,0) and 120B(0,0) deinterlaced. Macroblock 120′T(0,0) includes the first eight lines of pixels from macroblocks 120T(0,0) and 120B(0,0). Macroblock 120′B(0,0) includes the last eight lines of pixels from macroblocks 120T(0,0) and 120B(0,0).

As noted above, the motion vectors for partitions 130 are dependent on the motion vectors of the left A, top left corner D, top B, and top right corner C neighboring partitions. The location of these partitions depend on whether the macroblock pair, the left neighboring macroblock pair, top left corner, the top neighboring macroblock pair, and the top right neighboring macroblock pair are frame or field coded.

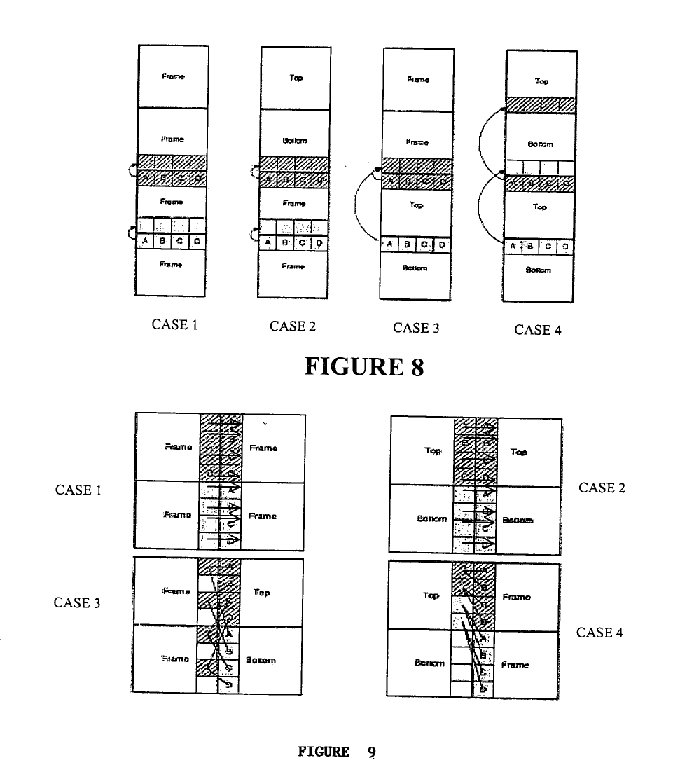

Referring now to FIG. 8, there is illustrated a block diagram describing the top neighboring partitions for the top row of partitions in macroblock pairs 120TB. In case 1, the macroblock pair 120TB and its top neighbor macroblock pair 120TB are both frame coded. The top neighbor partitions for partitions A, B, C, D are as indicated by the arrows.

In case 2, the macroblock pair 120TB is frame coded while its top neighbor macroblock pair 120TB is field coded. The top neighbor partitions for partitions A, B, C, D are as indicated by the arrows.

In case 3, the macroblock pair 120TB is frame coded while its top neighbor macroblock pair 120TB is field coded. The top neighbor partitions for partitions A, B, C, D are as indicated by the arrows.

In case 4, the macroblock pair 120TB and its top neighbor macroblock pair 120TB are both field coded. The top neighbor partitions for partitions A, B, C, D are as indicated by the arrows.

Referring now to FIG. 9, there is illustrated a block diagram describing the left neighboring partitions for the left column of partitions in macroblock pairs 120TB. In case 1, the macroblock pair 120TB and its left neighbor macroblock pair 120TB are both frame coded. The left neighbor partitions for partitions A, B, C, D are as indicated by the arrows.

In case 2, the macroblock pair 120TB and its left neighbor macroblock pair 120TB are both field coded. The left neighbor partitions for partitions A, B, C, D are as indicated by the arrows.

In case 3, the macroblock pair 120TB is field coded while its left neighbor macroblock pair 120TB is frame coded. The left neighbor partitions for partitions A, B, C, D are as indicated by the arrows.

In case 4, the macroblock pair 120TB is frame coded while its left neighbor macroblock pair 120TB is field coded. The left neighbor partitions for partitions A, B, C, D are as indicated by the arrows.

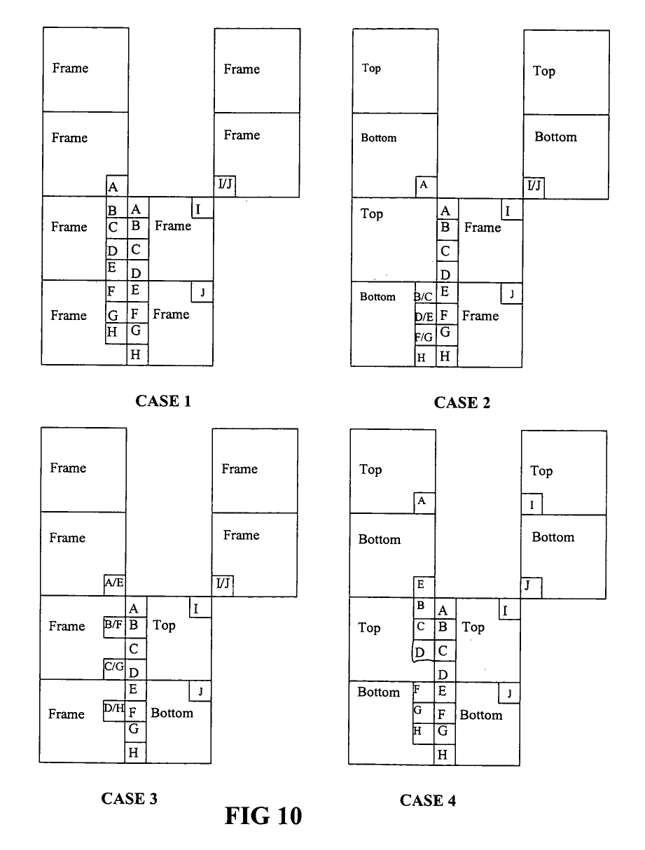

Referring now to FIG. 10, there is illustrated a block diagram describing the top left corner and top right corner neighbors, based on the coding of the macroblock pairs, for the top left corners A,E, left column B,C,D,F,G,H and top right corner I,J partitions in macroblock pairs 120TB.

The top left neighbor for the top left corner partitions A, E depend on the coding of the macroblock pair and the top left neighboring macroblock pair. The top left neighbor for the remaining left column, B,C,D,F,G,H depend on the coding of the macroblock pair and left neighbor macroblock pair. The top right neighbor of top right corner partitions I and J, depend on the coding of the macroblock pair and the top right neighboring macroblock pair.

In case 1, the macroblock pair and its top left neighbor, top left neighbor, and top right neighbor macroblock pair are all frame coded. The top left neighbor partitions for partition A . . . H are indicated. The top right neighbor partitions for partition I and J are also indicated.

In case 2, the macroblock pair is frame coded and its top left neighbor, top left neighbor, and top right neighbor macroblock pair are all field coded. The top left neighbor partitions for partition A . . . H are indicated. The top right neighbor partitions for partition I and J are also indicated.

In case 3, the macroblock pair is field coded and its top left neighbor, top left neighbor, and top right neighbor macroblock pair are all frame coded. The top left neighbor partitions for partition A . . . H are indicated. The top right neighbor partitions for partition I and J are also indicated.

In case 4, the macroblock pair and its top left neighbor, top left neighbor, and top right neighbor macroblock pair are all field coded. The top left neighbor partitions for partition A . . . H are indicated. The top right neighbor partitions for partition I and J are also indicated.

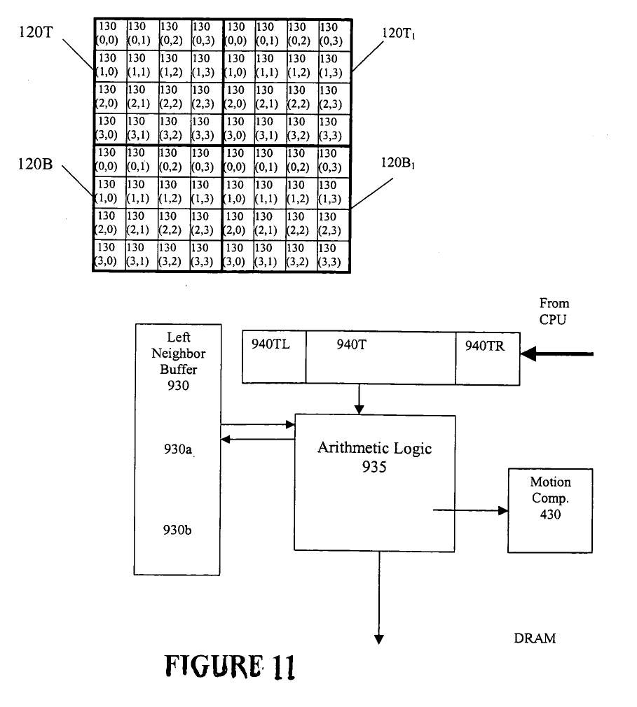

Referring now to FIG. 11, there is illustrated a block diagram describing certain aspects of the motion vector generator 515 in accordance with an embodiment of the present invention. The motion vector generator 515 includes a left neighbor buffer 930, arithmetic logic 935, top left, top, and top right neighbor buffers 940TL, 940T, and 940TR. The motion vector generator 515 generates motion vector(s) for each partition, and provides the motion vectors to a motion compensator 430. The motion compensator 430 uses the motion vectors to fetch the appropriate prediction pixels P.

The arithmetic logic 935 computes the motion vectors for partitions 130. Where a partition exceeds 4×4 pixels, e.g. partition 130X, the motion vectors for the partition 130X are associated with each constituent 4×4 partition 130. The motion vector generator 515 receives the video data on a macroblock by macroblock 120 basis.

When the motion vector generator 515 calculates the motion vectors for a partitions 130 in a macroblock pair 120T, 120B, the motion vector generator 515 writes the motion vectors to one half 930a of the left neighbor buffer 930. The arithmetic logic 935 uses the foregoing information, as well as information regarding the top neighboring partitions, top left neighboring partitions, and top right neighboring partitions to calculate the motion vectors for the next partition 130 in the macroblock pair 120T, 120B.

As can be seen from FIGS. 8 and 10, the bottom row of partitions 130(3,x) of the top neighboring macroblock pair 120T, 120B include all the top, top left, and top right neighboring partitions for a macroblock pair. As a macroblock pair row is traversed, the top, top left, and top right neighboring macroblock pairs traverse the previous row.

The CPU 510 computes the starting address of the top neighbor partitions, based on information about a macroblock pair, and the neighboring macroblock pairs. The CPU 510 fetches the information from the DRAM context buffer 410 for the top left neighboring partition (partitions 130(3,3) of the top left neighboring macroblock pair), the top right neighboring partitions (partitions 130(3,0) of the top right neighboring macroblock pair) and the top neighboring partitions (partitions 130(3,x) for the tope neighboring macroblock pair).Top left, top and top right neighbor buffers 940TL, 940T, and 940TR are for storing information from the top left, top, and top right neighboring partitions, respectively.

After decoding a macroblock pair 120T, 120B, the left neighbor buffer half 930a includes the motion vector for the right column of partitions 130(x,3) of the macroblocks 120T and 120B. The right column of partitions 130(x,) include all of the left neighbors for the next macroblock pair 120T₁, 120B₁. After the motion vectors for macroblock pair 120T, 120B are decoded, the arithmetic logic 935 writes the motion vectors for partitions 130(3,x) to the DRAM context buffer 410. These become the potential top left, top and top right partitions for macroblock pair 120T₁ and 120B₁.

Prior to decoding the next macroblocks 120T₁ and 120B₁, the information from the right column partitions 130(x,3) of macroblocks 120T and 120B, which includes all of the left neighbors of partitions 130(x,0) of macroblocks 120T₁ and 120B₁, is stored in the left neighbor buffer half 930a.

The arithmetic logic 935 selects the particular ones of the right column partitions of macroblock 120T/120B. The arithmetic logic 935 uses the information to compute the motion vectors for partitions 130(x,0) of macroblock pair 120T₁, 120B₁. The motion vectors for partitions 130(x,0) are written to the other half of the left neighbor buffer 930b.

The embodiments described herein may be implemented as a board level product, as a single chip, application specific integrated circuit (ASIC), or with varying levels of the decoder system integrated with other portions of the system as separate components.

The degree of integration of the decoder system will primarily be determined by the speed and cost considerations. Because of the sophisticated nature of modern processor, it is possible to utilize a commercially available processor, which may be implemented external to an ASIC implementation.

If the processor is available as an ASIC core or logic block, then the commercially available processor can be implemented as part of an ASIC device wherein certain functions can be implemented in firmware. Alternatively, the functions can be implemented as hardware accelerator units controlled by the processor.

While the present invention has been described with reference to certain embodiments, it will be understood by those skilled in the art that various changes may be made and equivalents may be substituted without departing from the scope of the present invention.

Additionally, many modifications may be made to adapt a particular situation or material to the teachings of the present invention without departing from its scope. For example, although the invention has been described with a particular emphasis on H.264 encoded video data, the invention can be applied to a video data encoded with a wide variety of standards.

Therefore, it is intended that the present invention not be limited to the particular embodiment disclosed, but that the present invention will include all embodiments falling within the scope of the appended claims.

1. A motion vector generator for generating motion vectors, said motion vector generator comprising:
arithmetic logic for calculating motion vectors for a portion of a picture; and
a neighbor buffer for storing information about another portion of the picture, said another portion being adjacent to the portion;
wherein the arithmetic logic calculates the motion vectors based on the information about the another portion of the picture.

2. The motion vector generator of claim 1, wherein the arithmetic logic calculates motion vectors associated with the portion of the picture and the another portion of the picture consecutively, wherein the arithmetic logic calculates the motion vectors of the another portion before decoding the motion vectors of the portion.

3. The motion vector generator of claim 1, wherein the portion and the another portion each comprise two macroblocks.

4. The motion vector generator of claim 3, further comprising:
a controller for selecting particular information from information about the another portion of the picture.

5. The motion vector generator of claim 4, wherein the macroblocks of the portion are field coded.

6. The motion vector generator of claim 4, wherein the macroblocks of the another portion are field coded.

7. The motion vector generator of claim 1, wherein the another portion is a left neighbor of the portion.

8. The motion vector generator of claim 7, further comprising:
a top neighbor buffer for storing information about a top neighboring portion to the portion; and
wherein the controller selects particular information from the information about the top neighboring portion to the portion.

9. An integrated circuit for generating motion vectors, said integrated circuit comprising:
arithmetic logic operable to calculate motion vectors for a portion of a picture; and
a neighbor buffer operable to store information about another portion of the picture, said another portion being adjacent to the portion, the neighbor buffer being operably coupled to the arithmetic logic;
wherein the arithmetic logic calculates the motion vectors based on the information about the another portion of the picture.

10. The integrated circuit of claim 9, wherein the arithmetic logic calculates motion vectors associated with the portion of the picture and the another portion of the picture consecutively, wherein the arithmetic logic calculates the motion vectors of the another portion before decoding the motion vectors of the portion.

11. The integrated circuit of claim 9, wherein the portion and the another portion each comprise two macroblocks.

12. The integrated circuit of claim 11, further comprising:
a controller operable to select particular information from information about the another portion of the picture, the controller being operably coupled to the arithmetic logic.

13. The integrated circuit of claim 12, wherein the macroblocks of the portion are field coded.

14. The integrated circuit of claim 12, wherein the macroblocks of the another portion are field coded.

15. The integrated circuit of claim 9, wherein the another portion is a left neighbor of the portion.

16. The motion vector generator of claim 15, further comprising:
a top neighbor buffer for storing information about a top neighboring portion to the portion; and
wherein the controller selects particular information from the information about the top neighboring portion to the portion.
